(19) United States
(12) Patent Application Publication
(10) Pub. No.: US 2020/0319052 A1
(43) Pub. Date: Oct. 8, 2020

(54) MULTI-POINT LIQUID LEAKAGE DETECTING METHOD AND SYSTEM THEREOF

(71) Applicant: Bo Feng, Shenzhen (CN)

(72) Inventor: Bo Feng, Shenzhen (CN)

(21) Appl. No.: 16/905,948

(22) Filed: Jun. 19, 2020

(51) Int. Cl. G01M 3/04; G01M 3/26

(52) U.S. Cl. CPC G01M 3/04; G01M 3/40; G01M 3/26

(57) ABSTRACT

The present invention discloses a multi-point liquid leakage detecting method and a system thereof, belonging to the technical field of liquid leakage detection. In the present invention, a detection master sends a detection instruction to a slave in real time. The slave detects a plurality of nodes to be detected according to the detection instruction, obtains the node information of each node to be detected, and feeds the node information back to the detection master. The detection master then judges whether there are liquid leakage nodes in the plurality of nodes to be detected according to the node information. When there are liquid leakage nodes in the plurality of nodes to be detected, the node identifier and the liquid leakage data corresponding to the liquid leakage node are obtained from the node information.

### TECHNICAL FIELD

The present invention relates to the technical field of liquid leakage detection, and in particular to a multi-point liquid leakage detecting method and a system thereof.

### BACKGROUND

With the continuous development of social economy and information technology, in the important fields of chemical industry, food, data security, medical treatment, etc., the leakage of various liquids has resulted in serious security problems. Liquid leakage may result in server failure or even burnout. Therefore, it is particularly important to prevent and detect liquid leakage in security and property issues today. To solve this problem, devices such as servers are usually detected manually using detection instruments one by one to find the liquid leakage device and the corresponding liquid leakage point.

However, the current detecting method and the detection instrument used in the detection can only detect a single leakage point, and cannot detect multiple leakage points at the same time. If there are many leakage points, they need to be detected one by one, which is time-consuming and low in efficiency. In the process, the leaked liquid will continue to increase, and even more serious safety hazards will occur.

### SUMMARY

The main object of the present invention is to provide a multi-point liquid leakage detecting method and a system thereof, aiming to solve the deficiencies in the background.

To achieve the above object, the present invention proposes a multi-point liquid leakage detecting method, comprising the steps of:

S10: sending, by a detection master, a detection instruction to a slave in real time;

S20: receiving, by the slave, the detection instruction, detecting a plurality of nodes to be detected according to the detection instruction, obtaining the node information of each node to be detected, and feeding the node information back to the detection master;

S30: receiving, by the detection master, the node information, and judging whether there are liquid leakage nodes in the plurality of nodes to be detected according to the node information;

S40: when there are liquid leakage nodes in the plurality of nodes to be detected, obtaining, by the detection master, the node identifier and the liquid leakage data corresponding to the liquid leakage node from the node information, and using the node identifier and the liquid leakage data as the detection result.

Preferably, the S1 specifically comprises the steps of:

S101: obtaining, by the terminal device, the IP address and the port number of the detection master;

S102: modifying, by the terminal device, the IP address and the port number, so that the gateway of the detection master and the gateway of the terminal device are in the same state, and sending a collection instruction to the detection master through a preset protocol in the same gateway state;

S103: receiving, by the detection master, the collection instruction, and sending the detection instruction to the slave in real time according to the collection instruction.

Preferably, the S20 specifically comprises the steps of:

S201: detecting, by the slave, whether there is a circuit loop in each sensor line according to the detection instruction issued by the detection master;

S202: obtaining, by the slave, the current value of the liquid leakage resistance corresponding to the circuit loop when there is a circuit loop;

S203: obtaining, by the slave, the node identifier and the liquid leakage data of each node to be detected, and feeding the current value, the node identifier, and the liquid leakage data back to the detection master as node information.

Preferably, the S30 specifically comprises the steps of:

S301: extracting, by the detection master, the current value of the liquid leakage resistance from the node information fed back by the slave, and comparing the current value with a preset current threshold;

S302: when the current value is greater than the preset current threshold, determining, by the detection master, that the node to be detected, which is connected to the sensor line corresponding to the circuit loop, is a liquid leakage node.

Preferably, the S40 specifically comprises the steps of:

S401: uploading, by the detection master, the detection result to the terminal device through serial communication or wired network at a preset time interval;

S402: receiving, by the terminal device, the detection result uploaded by the detection master, and extracting the liquid leakage data from the detection result;

S403: comparing, by the terminal device, the liquid leakage data with a preset liquid leakage threshold, and dividing the failure level of the liquid leakage node according to the comparison result;

S404: generating, by the terminal device, a corresponding dot matrix code according to the failure level and the node identifier corresponding to the liquid leakage node, and displaying the dot matrix code.

A multi-point liquid leakage detecting system is provided, which is used to implement the above multi-point liquid leakage detecting method, comprising:

a detection master and a slave, wherein the detection master and the slave are connected through a communication bus, and the slave is connected to a plurality of nodes to be detected through a plurality of sensor lines;

the detection master is configured to send a detection instruction to the slave in real time;

the detection master is further configured to receive the node information, and judge whether there are liquid leakage nodes in the plurality of nodes to be detected according to the node information;

the detection master is further configured to obtain the node identifier and the liquid leakage data corresponding to the liquid leakage node from the node information, and use the node identifier and the liquid leakage data as the detection result, when there are liquid leakage nodes in the plurality of nodes to be detected;

the slave is configured to receive the detection instruction, detect a plurality of nodes to be detected according to the detection instruction, obtain the node information of each node to be detected, and feed the node information back to the detection master.

Preferably, the system further comprises: a terminal device;

the terminal device is configured to obtain the IP address and the port number of the detection master;

the terminal device is further configured to modify the IP address and the port number, so that the gateway of the detection master and the gateway of the terminal device are in the same state, and send a collection instruction to the detection master through a preset protocol in the same gateway state, and the detection master sends the detection instruction to the slave in real time according to the collection instruction after receiving the collection instruction.

Preferably, the slave is further configured to detect whether there is a circuit loop in each sensor line according to the detection instruction issued by the detection master;

the slave is further configured to obtain the current value of the liquid leakage resistance corresponding to the circuit loop when there is a circuit loop;

the slave is further configured to obtain the node identifier and the liquid leakage data of each node to be detected, and feed the current value, the node identifier, and the liquid leakage data back to the detection master as node information.

Preferably, the detection master is configured to extract the current value of the liquid leakage resistance from the node information fed back by the slave, and compare the current value with a preset current threshold;

the detection master is further configured to determine that the node to be detected, which is connected to the sensor line corresponding to the circuit loop, is a liquid leakage node when the current value is greater than the preset current threshold;

the detection master is further configured to upload the detection result to the terminal device through serial communication or wired network at a preset time interval.

Preferably, the terminal device is configured to receive the detection result uploaded by the detection master, and extract the liquid leakage data from the detection result;

the terminal device is further configured to compare the liquid leakage data with a preset liquid leakage threshold, and divide the failure level of the liquid leakage node according to the comparison result;

the terminal device is further configured to generate a corresponding dot matrix code according to the failure level and the node identifier corresponding to the liquid leakage node, and display the dot matrix code.

In the present invention, a detection master sends a detection instruction to a slave in real time. The slave detects a plurality of nodes to be detected according to the detection instruction, obtains the node information of each node to be detected, and feeds the node information back to the detection master. The detection master then judges whether there are liquid leakage nodes in the plurality of nodes to be detected according to the node information. When there are liquid leakage nodes in the plurality of nodes to be detected, the node identifier and the liquid leakage data corresponding to the liquid leakage node are obtained from the node information. The detection master can simultaneously detect leakage information at multiple points and upload it to a terminal device in real time, thereby making liquid leakage detection more comprehensive and improving detection efficiency.

### BRIEF DESCRIPTION OF THE DRAWINGS

In order to more clearly explain the technical solutions in the embodiments of the present invention or the prior art, the drawings required in the embodiments or the description of the prior art will be briefly introduced. It is obvious that the drawings in the following description are only a part of embodiments of the present invention. Other drawings can be obtained according to the structures or methods shown in these drawings by those skilled in the art without paying any creative labor.

FIG. 1 is a flow diagram of a multi-point liquid leakage detecting method according to the present invention;

FIG. 2 is a flow schematic diagram of an embodiment of a multi-point liquid leakage detecting method according to the present invention;

FIG. 3 is a flow schematic diagram of another embodiment of a multi-point liquid leakage detecting method according to the present invention;

FIG. 4 is a structural block diagram of a multi-point liquid leakage detecting system according to the present invention;

FIG. 5 is a schematic diagram of a node detection circuit of a multi-point liquid leakage detecting system according to the present invention.

The implementation, functional characteristics and advantages of the present invention will be further described in conjunction with the embodiments and with reference to the drawings.

### DESCRIPTION OF THE EMBODIMENTS

The technical solutions in the embodiments of the present invention will be described clearly and completely in conjunction with the drawings in the embodiments of the present invention. Obviously, the described embodiments are only a part of the embodiments of the present invention, rather than all the embodiments. Based on the embodiments of the present invention, all other embodiments obtained by those skilled in the art without paying any creative labor fall within the protection scope of the present invention.

It should be noted that all the directional indicators (such as upper, lower, left, right, front, back, etc.) in the embodiments of the present invention are only used to explain the relative positional relationship, movement conditions, etc. between the components in a specific posture (as shown in the figures). If the specific posture changes, the directional indicator changes accordingly.

In addition, descriptions related to “first”, “second”, etc. in the present invention are for descriptive purposes only, and cannot be understood as indicating or implying their relative importance or implicitly indicating the number of indicated technical features. Thus, the features defined with “first” and “second” may comprise at least one of the features explicitly or implicitly. In addition, the technical solutions between the various embodiments can be combined with each other, but they must be based on the ability of those skilled in the art to realize. When the combination of technical solutions contradicts or cannot be realized, it should be considered that there is no combination of such technical solutions, and such technical solutions do not fall within the protection scope of the claims of the present invention.

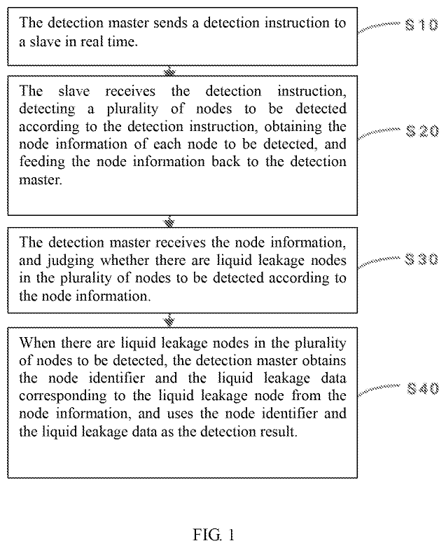

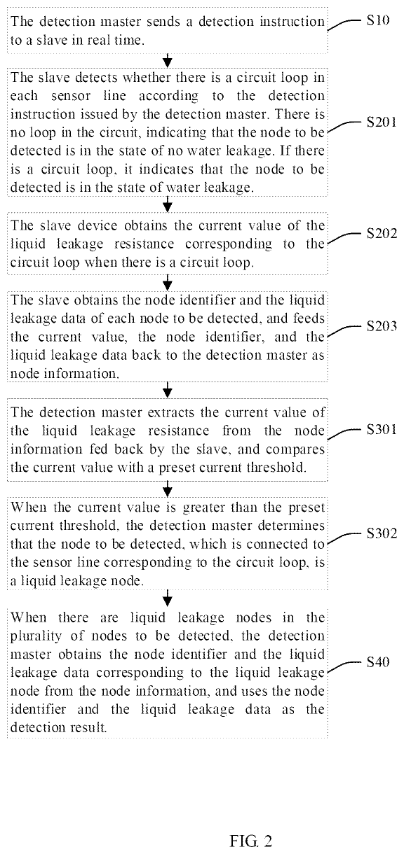

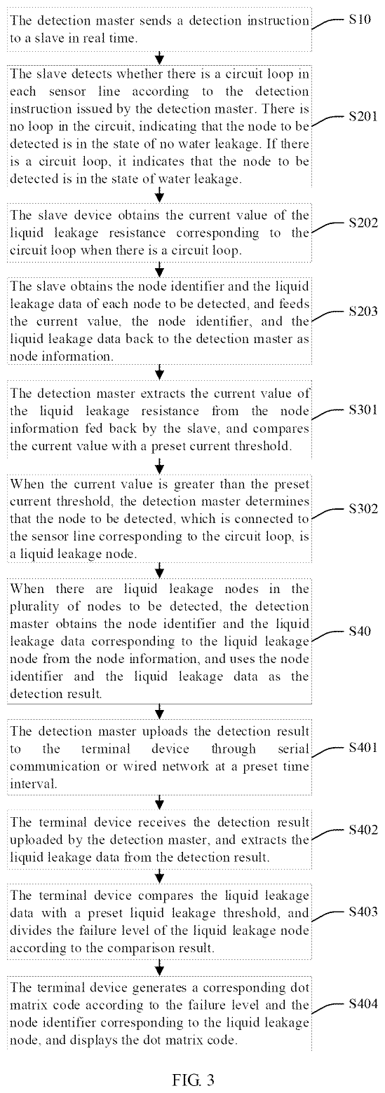

In an embodiment of the present invention, referring to FIGS. 1 to 3, the multi-point liquid leakage detecting method comprises the following steps.

S10: A detection master sends a detection instruction to a slave in real time.

In this embodiment, the detection master needs to receive the collection instruction sent by the terminal device when sending the detection instruction to the slave. The terminal device needs to ensure that the terminal device and the gateway of the detection master are in the same state when sending the collection instruction to the detection master. In this embodiment, the terminal device can modify the IP address and the port number of the detection master. By modifying the IP address and the port number of the detection master, it is ensured that the gateway of the terminal device and the gateway of the detection master are in the same state. When both gateways are in the same state, the terminal device 30 sends the collection instruction to the detection master through a preset protocol. In this embodiment, the preset protocol comprises Modbus communication protocol, etc., which is not limited in this embodiment. After receiving the collection instruction sent by the terminal device, the detection master sends a detection instruction to the slave.

S20: The slave receives the detection instruction sent by the detection master, detects a plurality of nodes to be detected according to the detection instruction, and obtains the node information of each node to be detected through the detection, wherein the node information comprises the node identifier of the node to be detected, and the current state of the node, etc., and after obtaining the node information of each node to be detected, the slave feeds the node information back to the detection master through the sensor line. This S20 specifically comprises the following steps.

S201: The slave detects whether there is a circuit loop in each sensor line according to the detection instruction issued by the detection master. There is no loop in the circuit, indicating that the node to be detected is in the state of no water leakage. If there is a circuit loop, it indicates that the node to be detected is in the state of water leakage.

S202: The slave device obtains the current value of the liquid leakage resistance corresponding to the circuit loop when there is a circuit loop.

S203: The slave obtains the node identifier and the liquid leakage data of each node to be detected, and feeds the current value, the node identifier, and the liquid leakage data back to the detection master as node information.

In the specific implementation, the slave also obtains the node identifier and the liquid leakage data of each node to be detected, and can assign different types, character string values or names to the nodes to distinguish each node. The liquid leakage data comprises the number of meters of liquid leakage, the volume of the liquid leakage and the speed of the liquid leakage, etc. The current value of the liquid leakage resistance, the node identifier and the liquid leakage data are fed back to the detection master as node information.

S30: The detection master receives the node information, and judges whether there are liquid leakage nodes in the plurality of nodes to be detected according to the node information. This S30 specifically comprises the following steps.

S301: The detection master extracts the current value of the liquid leakage resistance from the node information fed back by the slave, and compares the current value with a preset current threshold.

S302: When the current value is greater than the preset current threshold, the detection master determines that the node to be detected, which is connected to the sensor line corresponding to the circuit loop, is a liquid leakage node.

In this embodiment, the detection master receives the node information fed back from the slave, and extracts the current value of the liquid leakage resistance from the node information. It is easy to understand that if there is a circuit loop in the detection line connecting the slave and the node to be detected, it indicates that there is a liquid leakage in the corresponding node to be detected, but in fact, the liquid leakage can be divided into a variety of situations, such as no liquid leakage, slight liquid leakage, and serious liquid leakage. In this embodiment, the level of the liquid leakage is divided by setting the preset current threshold flowing through the liquid leakage resistor. When the current value flowing through the liquid leakage resistor is greater than the preset current threshold, it is determined that the liquid leakage level is more serious, so that the node to be detected corresponding to the circuit loop where the liquid leakage resistor in which the current value is greater than the preset current threshold is located is determined to be a leakage node. When the current value flowing through the liquid leakage resistor is less than or equal to the preset current threshold, it is determined that the liquid leakage level is not serious, so that the node to be detected corresponding to the circuit loop where the liquid leakage resistor in which the current value is greater than the preset current threshold is located is determined to be a normal node. The preset current threshold may be 900 μA or 850 μA, which can be set according to the actual situation and is not limited in this embodiment.

Further, the detection master receives the node information fed back by the slave, analyzes the node information of each node to be detected one by one, and determines whether there is node information related to liquid leakage in the node information. If there is node information related to liquid leakage in the node information, it indicates that the node to be detected corresponding to the node information is a liquid leakage node, and the node identifier and the liquid leakage data of the liquid leakage node are extracted from the node information. The node identifier can be set by itself, as long as the normal node can be distinguished from the liquid leakage node. The liquid leakage data comprises the number of meters of liquid leakage, the volume of the liquid leakage and the speed of the liquid leakage, etc. The obtained node identifier and the liquid leakage data of the liquid leakage node are the results of the multi-point liquid leakage detection.

In this embodiment, the slave detects whether there is a circuit loop in each sensor line according to the detection instruction issued by the detection master. When there is a circuit loop, the current value of the liquid leakage resistance corresponding to the circuit loop is obtained, the node identifier and the liquid leakage data of each node to be detected are then obtained, and the current value, the node identifier and the liquid leakage data are fed back to the detection master as node information. The detection master extracts the current value of the liquid leakage resistance from the node information, compares the current value with the preset current threshold, and when the current value is greater than the preset current threshold, determines that the node to be detected, which is connected to the sensor line corresponding to the circuit loop, is a liquid leakage node, which improves the detection accuracy of the liquid leakage node.

S40: When there are liquid leakage nodes in the plurality of nodes to be detected, the detection master obtains the node identifier and the liquid leakage data corresponding to the liquid leakage node from the node information, and uses the node identifier and the liquid leakage data as the detection result. This S40 specifically comprises the following steps.

S401: The detection master uploads the detection result to the terminal device through serial communication or wired network at a preset time interval.

S402: The terminal device receives the detection result uploaded by the detection master, and extracts the liquid leakage data from the detection result;

S403: The terminal device compares the liquid leakage data with a preset liquid leakage threshold, and divides the failure level of the liquid leakage node according to the comparison result;

S404: The terminal device generates a corresponding dot matrix code according to the failure level and the node identifier corresponding to the liquid leakage node, and displays the dot matrix code.

In this embodiment, the detection master uploads the obtained detection result to the terminal device, and the uploading operation is performed at a preset time interval. Considering the actual situation, the liquid leakage speed is generally slow. Uploading the detection result at a preset time interval can also reduce the load of the terminal device. The preset time interval can be 5 S or 10 S, which can be set according to the actual situation. The uploading method comprises serial communication or wired network.

In a specific implementation, the terminal device extracts the liquid leakage data from the detection result, compares the liquid leakage data with a preset liquid leakage threshold, wherein the preset liquid leakage threshold comprises a liquid leakage distance threshold, a liquid leakage speed threshold, and a liquid leakage meter number threshold, etc., and divides the failure level of the liquid leakage node according to the comparison result. For example, the liquid leakage speed threshold is 0.05 kg/s. Assuming that the liquid leakage speed extracted from the detection result of the liquid leakage node a is 0.1 kg/s, the failure level of the liquid leakage node a is divided into three levels. The liquid leakage speed extracted from the detection result of the liquid leakage node b is 0.08 kg/s, and then the failure level of the liquid leakage node b is divided into 1 level. The specific failure level is divided and the liquid leakage threshold is set, which is not limited in this embodiment.

Further, after the failure level of each liquid leakage node is divided, a corresponding dot matrix code is generated according to the node identifier and failure level corresponding to the liquid leakage node. The dot matrix code is displayed on the display screen of the terminal device. The user can view the node identifier and corresponding liquid leakage data corresponding to each point on the dot matrix code through the display screen, which is convenient for users to view and maintain in real time.

In this embodiment, the detection master uploads the detection result to the terminal device through serial communication or wired network at a preset time interval. The terminal device extracts the liquid leakage data from the detection result, compares the liquid leakage data with the preset liquid leakage threshold, divides the failure level of the liquid leakage node according to the comparison result, then generates the corresponding dot matrix code according to the failure level and the node identifier corresponding to the liquid leakage node, and displays the dot matrix code. The failure level is displayed by the dot matrix code, which is convenient for users to view so that the users clearly and quickly locate the liquid leakage point. At the same time, the detection efficiency of the liquid leakage is improved.

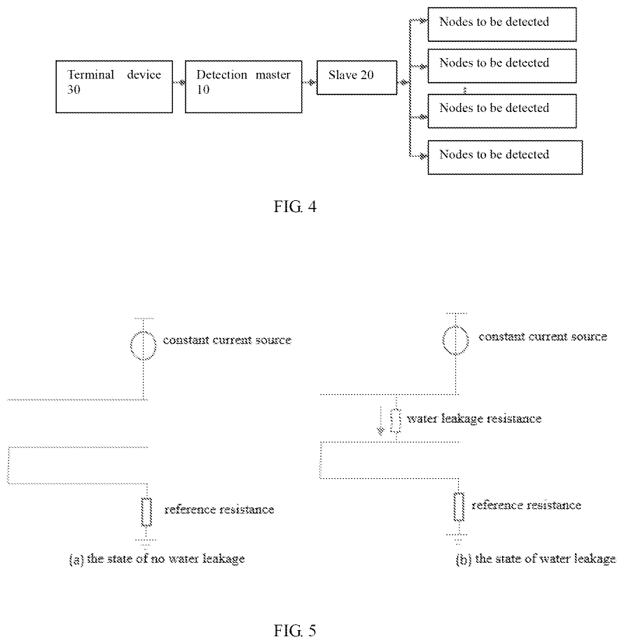

This embodiment also provides a multi-point liquid leakage detecting system, which is used to implement the above multi-point liquid leakage detecting method. Referring to FIG. 4, the system comprises:

a detection master 10 and a slave 20, wherein the detection master 10 and the slave 20 are connected through a communication bus, and the slave 20 is connected to a plurality of nodes to be detected through a plurality of sensor lines;

the detection master 10 is configured to send a detection instruction to the slave 20 in real time;

the detection master 10 is further configured to receive the node information, and judge whether there are liquid leakage nodes in the plurality of nodes to be detected according to the node information;

the detection master 10 is further configured to obtain the node identifier and the liquid leakage data corresponding to the liquid leakage node from the node information, and use the node identifier and the liquid leakage data as the detection result, when there are liquid leakage nodes in the plurality of nodes to be detected;

the slave 20 is configured to receive the detection instruction, detect a plurality of nodes to be detected according to the detection instruction, obtain the node information of each node to be detected, and feed the node information back to the detection master 10.

In this embodiment, the detection master 10 is connected to the slave 20 through a communication bus, and the slave 20 uploads the collected data to the detection master 10 through a general-purpose bus. In this embodiment, the communication method used by the detection master 10 and the slave 20 is preferably 485-serial communication. The used communication protocol is preferably Modbus communication protocol. The detection master 10 is preferably an embedded master. The STM32F10X series chip is used as the main chip of the embedded master. The communication method, the communication protocol and the master selecting method described above can all be changed according to the actual situation, and are not limited in this embodiment.

There may be one or more slaves 20. Each slave 20 communicates with the detection master 10 through a corresponding communication bus. Each slave 20 is connected to the device to be detected through a sensor. In this embodiment, the detecting method used by the device to be detected is multi-point detection. Therefore, each slave 20 needs to be connected to the node to be detected of the device to be detected through a plurality of sensor lines to achieve multi-point detection. The node to be detected can be understood as the point on the device to be detected in which liquid leakage detection is required. In addition, in this embodiment, the liquid leakage detection comprises oil leakage detection or water leakage detection, such as detecting whether the oil tank is leaking, detecting whether the ceiling of a server room is leaking, etc.

In this embodiment, referring to FIG. 5, the sensor line connecting the slave 20 and the node to be detected uses a three-core detection line. The three-core line consists of two non-resistance wires and one resistance wire. One of the insulated wires is connected with the resistance wire, and the other end of the insulated wire is connected to a reference resistance (which is used to measure the voltage during water leakage). One end of the other insulated wire is connected to a constant current source for the liquid leakage detection in this embodiment. Taking water leakage detection as an example, the slave 20 detects the circuit loop after receiving the detection instruction. As shown in FIG. 5(a), the insulated wire is disconnected from the other two wires, and there is no loop in the circuit, indicating that the node to be detected is in the state of no water leakage. If there is a circuit loop, it indicates that the node to be detected is in the state of water leakage. As shown in FIG. 5(b), when the node to be detected is in the state of water leakage, there is a water leakage resistance between the insulated wire connecting the constant current source and the resistance wire, which forms a circuit loop. The reference resistance and the voltage of the resistance wire are then measured, the data is processed, and the current value flowing through the water leakage resistance is obtained.

Further, the multi-point liquid leakage detecting system further comprises:

a terminal device 30, which is configured to obtain the IP address and the port number of the detection master 10;

the terminal device 30 is further configured to modify the IP address and the port number, so that the gateway of the detection master and the gateway of the terminal device are in the same state, and send a collection instruction to the detection master through a preset protocol in the same gateway state, and the detection master sends the detection instruction to the slave in real time according to the collection instruction after receiving the collection instruction.

In this embodiment, the terminal device 30 is a device that inputs programs and data to the computer via a communication device or receives the processing result output by the computer, comprising a desktop computer, a notebook computer, etc. The terminal device 30 establishes a communication connection with the detection master 10 through a communication interface. The communication interface comprises a 485-communication serial port or a wired network interface.

Preferably, the slave 20 is further configured to detect whether there is a circuit loop in each sensor line according to the detection instruction issued by the detection master 10; and obtain the current value of the liquid leakage resistance corresponding to the circuit loop when there is a circuit loop.

Further, the slave 20 is further configured to obtain the node identifier and the liquid leakage data of each node to be detected, and feed the current value, the node identifier, and the liquid leakage data back to the detection master 10 as node information.

Preferably, the detection master 10 is configured to extract the current value of the liquid leakage resistance from the node information fed back by the slave, and compare the current value with a preset current threshold; and determine that the node to be detected, which is connected to the sensor line corresponding to the circuit loop, is a liquid leakage node when the current value is greater than the preset current threshold.

Further, the detection master 10 is further configured to upload the detection result to the terminal device through serial communication or wired network at a preset time interval.

Preferably, the terminal device 30 is configured to receive the detection result uploaded by the detection master 10, extract the liquid leakage data from the detection result; compare the liquid leakage data with a preset liquid leakage threshold, and divide the failure level of the liquid leakage node according to the comparison result.

Further, the terminal device 30 is further configured to generate a corresponding dot matrix code according to the failure level and the node identifier corresponding to the liquid leakage node, and display the dot matrix code.

It should be noted that: through the description of the above embodiments, those skilled in the art can clearly understand that the methods in the above embodiments can be implemented by means of software plus a necessary general-purpose hardware platform, and of course, the methods can also be implemented by hardware. However, in many cases, the former is the better implementation. Based on this understanding, the technical solution of the present invention can be embodied in the form of a software product in essence or in the part that contributes to the prior art. The computer software product is stored in a storage medium (such as a Read Only Memory (ROM)/RAM, a magnetic disk, and an optical disk), comprising several instructions to enable a terminal device (which may be a mobile phone, a computer, a server, or a network device, etc.) to perform the methods described in the embodiments of the present invention.

The above are only preferred embodiments of the present invention, rather than limit the patent scope of the present invention. All the equivalent structures or equivalent process transformations made by the description and drawings of the present invention, which are directly or indirectly used in other related technical fields, are similarly included in the patent protection scope of the present invention.

What is claimed is:

1. A multi-point liquid leakage detecting method, comprising the steps of:
S10: sending, by a detection master, a detection instruction to a slave in real time;
S20: receiving, by the slave, the detection instruction, detecting a plurality of nodes to be detected according to the detection instruction, obtaining the node information of each node to be detected, and feeding the node information back to the detection master;
S30: receiving, by the detection master, the node information, and judging whether there are liquid leakage nodes in the plurality of nodes to be detected according to the node information;
S40: when there are liquid leakage nodes in the plurality of nodes to be detected, obtaining, by the detection master, the node identifier and the liquid leakage data corresponding to the liquid leakage node from the node information, and using the node identifier and the liquid leakage data as the detection result.

2. The multi-point liquid leakage detecting method according to claim 1, wherein the S1 specifically comprises the steps of:
S101: obtaining, by the terminal device, the IP address and the port number of the detection master,
S102: modifying, by the terminal device, the IP address and the port number, so that the gateway of the detection master and the gateway of the terminal device are in the same state, and sending a collection instruction to the detection master through a preset protocol in the same gateway state;
S103: receiving, by the detection master, the collection instruction, and sending the detection instruction to the slave in real time according to the collection instruction.

3. The multi-point liquid leakage detecting method according to claim 1, wherein the S20 specifically comprises the steps of:
S201: detecting, by the slave, whether there is a circuit loop in each sensor line according to the detection instruction issued by the detection master;
S202: obtaining, by the slave, the current value of the liquid leakage resistance corresponding to the circuit loop when there is a circuit loop;
S203: obtaining, by the slave, the node identifier and the liquid leakage data of each node to be detected, and feeding the current value, the node identifier, and the liquid leakage data back to the detection master as node information.

4. The multi-point liquid leakage detecting method according to claim 1, wherein the S30 specifically comprises the steps of:
S301: extracting, by the detection master, the current value of the liquid leakage resistance from the node information fed back by the slave, and comparing the current value with a preset current threshold;
S302: when the current value is greater than the preset current threshold, determining, by the detection master, that the node to be detected, which is connected to the sensor line corresponding to the circuit loop, is a liquid leakage node.

5. The multi-point liquid leakage detecting method according to claim 1, wherein the S40 specifically comprises the steps of:
S401: uploading, by the detection master, the detection result to the terminal device through serial communication or wired network at a preset time interval;
S402: receiving, by the terminal device, the detection result uploaded by the detection master, and extracting the liquid leakage data from the detection result;
S403: comparing, by the terminal device, the liquid leakage data with a preset liquid leakage threshold, and dividing the failure level of the liquid leakage node according to the comparison result;
S404: generating, by the terminal device, a corresponding dot matrix code according to the failure level and the node identifier corresponding to the liquid leakage node, and displaying the dot matrix code.

6. A multi-point liquid leakage detecting system, wherein the system is used to implement the multi-point liquid leakage detecting method according to claim 1, comprising:
a detection master and a slave, wherein the detection master and the slave are connected through a communication bus, and the slave is connected to a plurality of nodes to be detected through a plurality of sensor lines;
the detection master is configured to send a detection instruction to the slave in real time;
the detection master is further configured to receive the node information, and judge whether there are liquid leakage nodes in the plurality of nodes to be detected according to the node information;
the detection master is further configured to obtain the node identifier and the liquid leakage data corresponding to the liquid leakage node from the node information, and use the node identifier and the liquid leakage data as the detection result, when there are liquid leakage nodes in the plurality of nodes to be detected;
the slave is configured to receive the detection instruction, detect a plurality of nodes to be detected according to the detection instruction, obtain the node information of each node to be detected, and feed the node information back to the detection master.

7. The multi-point liquid leakage detecting system according to claim 6, wherein the system further comprises: a terminal device;
the terminal device is configured to obtain the IP address and the port number of the detection master,
the terminal device is further configured to modify the IP address and the port number, so that the gateway of the detection master and the gateway of the terminal device are in the same state, and send a collection instruction to the detection master through a preset protocol in the same gateway state, and the detection master sends the detection instruction to the slave in real time according to the collection instruction after receiving the collection instruction.

8. The multi-point liquid leakage detecting system according to claim 6, wherein the slave is further configured to detect whether there is a circuit loop in each sensor line according to the detection instruction issued by the detection master,
the slave is further configured to obtain the current value of the liquid leakage resistance corresponding to the circuit loop when there is a circuit loop;
the slave is further configured to obtain the node identifier and the liquid leakage data of each node to be detected, and feed the current value, the node identifier, and the liquid leakage data back to the detection master as node information.

9. The multi-point liquid leakage detecting system according to claim 6, wherein the detection master is configured to extract the current value of the liquid leakage resistance from the node information fed back by the slave, and compare the current value with a preset current threshold;
the detection master is further configured to determine that the node to be detected, which is connected to the sensor line corresponding to the circuit loop, is a liquid leakage node when the current value is greater than the preset current threshold;
the detection master is further configured to upload the detection result to the terminal device through serial communication or wired network at a preset time interval.

10. The multi-point liquid leakage detecting system according to claim 7, wherein the terminal device is configured to receive the detection result uploaded by the detection master, and extract the liquid leakage data from the detection result;
the terminal device is further configured to compare the liquid leakage data with a preset liquid leakage threshold, and divide the failure level of the liquid leakage node according to the comparison result;
the terminal device is further configured to generate a corresponding dot matrix code according to the failure level and the node identifier corresponding to the liquid leakage node, and display the dot matrix code.
